(19) United States
(12) Patent Application Publication
(10) Pub. No.: US 2021/0373593 A1
(43) Pub. Date: Dec. 2, 2021

(54) EAR PHYSIOLOGICAL WEARABLE DEVICE

(71) Applicant: NATIONAL DEFENSE MEDICAL CENTER, Taipei City (TW)

(72) Inventors: Tong-Jing FANG, Taichung City (TW); Lih-Jen KAU, Hualien City, Hualien County (TW); Juin-Hong CHERNG, Taipei City (TW); Hsiang-Cheng CHEN, Taipei City (TW); Kae-Shin LIN, Taipei City (TW); Gang-Yi FAN, New Taipei City (TW); Shu-Jen CHANG, Taipei City (TW)

(21) Appl. No.: 17/329,833

(22) Filed: May 25, 2021

(30) Foreign Application Priority Data
May 28, 2020 (TW) 109206614

(51) Int. Cl. G06F 1/16; G06F 1/20

(52) U.S. Cl. CPC G06F 1/163; G06F 1/206

(57) ABSTRACT

An ear physiological wearable device, including a main body and a supporting body, is provided. The main body includes an acoustic driving portion, a temperature sensing portion and an optical scanning portion. The acoustic driving portion is adjacent to the temperature sensing portion, and the optical scanning portion is disposed below the acoustic driving portion and the temperature sensing portion. The supporting body is connected to the main body. The acoustic driving portion includes an acoustic outlet, and the temperature sensing portion includes a nozzle. Two ear physiological wearable devices, one of them including an acoustic driving portion with an acoustic end against the user's skull, another including a main body including a temperature sensing portion and an optical scanning portion, are provided. In this way, the audio signal can be transmitted and/or the users' physiological status can be sensed.

### CROSS-REFERENCES TO RELATED APPLICATIONS

This application claims priority to Taiwan Patent Application No. 109206614 filed on May 28, 2020, which is hereby incorporated by reference in its entirety.

### BACKGROUND OF THE INVENTION

### Field of the Invention

The present invention relates to an ear physiological wearable device, and in particular, relates to an ear physiological wearable device which can transmit sound and/or sense the status of a user.

### Descriptions of the Related Art

At present, most common wearable devices are worn on the wrists of users so that users can watch messages directly from the devices or watch the recorded data of the devices after connecting the devices to external devices (such as mobile phones, tablets, laptops, etc.).

However, in the intense training and drills that are continuous and difficult to be interrupted, users are confronted with a situation where they cannot spare their hands to watch messages or take out other equipment to know their own status immediately; or, in sports where hand accessories cannot be worn, athletes cannot know their own status quickly.

For another example, some patients with physiological diseases sometimes forget to use the devices actively to check their own status, or they cannot operate or use the hand wearable devices.

The above situations usually require more convenient and immediate monitoring methods, or obvious prompts for other external personnel to notice and give reminders or assistance.

In addition, a device that can be integrated, convenient to carry, and does not require users to take the initiative to remember the measurements is unavailable currently for obtaining important indicators of physiological condition, such as body temperature, blood pressure, blood oxygen, or the like.

Accordingly, an urgent need exists in the art to improve the above drawbacks.

### SUMMARY OF THE INVENTION

An objective of the present invention is to provide an ear physiological wearable device, which can eliminate one or more problems existing in the prior art and provide functions, including receiving/providing audio messages, physiological monitoring, abnormal warning and/or dynamic sensing to meet use requirements.

In order to achieve the above objective, an ear physiological wearable device provided by the present invention comprises a main body and a supporting body. The main body includes an acoustic driving portion, a temperature sensing portion being adjacent to the acoustic driving portion, and an optical scanning portion disposed below the acoustic driving portion and the temperature sensing portion. The supporting body is connected to the main body, allowing a user to wear the ear physiological wearable device. The acoustic driving portion includes an acoustic outlet, the temperature sensing portion includes a nozzle, and when the user wears the ear physiological wearable device, the acoustic outlet and the nozzle face to the ear canal of the user.

In order to achieve the above objective, another ear physiological wearable device provided by the present invention comprises a main body and a supporting body. The main body includes an acoustic driving portion including an acoustic end; a temperature sensing portion including a nozzle; and an optical scanning portion. When the user wears the ear physiological wearable device, the acoustic end abuts against the user's skull, and the temperature sensing portion extends along the ear canal of the user, so that the nozzle is positioned in the ear canal of the user.

In order to achieve the above objective, a main body of yet another ear physiological wearable device provided by the present invention includes a temperature sensing portion and an optical scanning portion (optionally including an acoustic driving portion), when the user wears the ear physiological wear device, the temperature sensing portion extends along the ear canal of the user, so that a nozzle of the temperature sensing portion is positioned in the ear canal of the user, and an opening of the optional scanning portion corresponds to the incisura intertragica of the user.

In an embodiment, the ear physiological wearable device of the present invention further comprises a wireless signal transmission module that is electrically connected with the acoustic driving portion, the temperature sensing portion and/or the optical scanning portion.

In an embodiment, an angle is included between the acoustic outlet and the nozzle comprised in the ear physiological wearable device of the present invention, and the angle is not greater than 30 degrees.

In an embodiment, the optical scanning portion comprised in the ear physiological wearable device of the present invention includes an opening, and when the user wears the ear physiological wearable device, the opening faces the incisura intertragica of the user.

In an embodiment, the supporting body comprised in the ear physiological wearable device of the present invention comprises a first operating portion and a supporting portion, the supporting portion is connected with the first operating portion, and when the user wears the ear physiological wearable device, the supporting portion is located on the outer helix or beside the back of the ear of the user.

In an embodiment, a central axis of the first operating portion comprised in the ear physiological wearable device of the present invention is inclined relative to an extension axis normal of the supporting portion.

In an embodiment, the first operating portion comprised in the ear physiological wearable device of the present invention may include a finger contact area, an indication area and/or a data transmission area.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is an explanatory diagram of various portions of a human ear;

FIG. 2 is a schematic perspective view of an ear physiological wearable device according to a first preferred embodiment of the present invention;

FIG. 3A and FIG. 3B are schematic perspective views respectively of two kinds of main bodies according to the first preferred embodiment of the present invention; and

FIG. 4 is a schematic view of the ear physiological wearable device being worn according to the first preferred embodiment of the present invention (only the main body is shown);

FIG. 5A and FIG. 5B are respectively a side view and a top view of the main body according to the first preferred embodiment of the present invention;

FIG. 6 is a side view of a supporting body according to the first preferred embodiment of the present invention (the main body is not shown);

FIG. 7 is a schematic view of an ear physiological wearable device being worn according to a second preferred embodiment of the present invention; and

FIG. 8A to FIG. 8C are respectively schematic perspective views of an ear physiological wearable device according to a third preferred embodiment of the present invention (FIG. 8A only shows the main body).

### DESCRIPTION OF THE PREFERRED EMBODIMENT

Specific embodiments according to the present invention will be specifically described below. However, without departing from the spirit of the present invention, the present invention may be practiced in many different forms of embodiments, and the scope claimed in the present invention should not be interpreted as being limited to what stated in the specification.

Unless the context clearly indicates otherwise, singular forms “a”, “the” and similar terms used herein also include plural forms, and terms “first”, “second” or the like are used herein to describe various elements or components, rather than indicating that these elements or components have necessary orders or priorities. In addition, orientations (such as, front, back, up, down, left, right, side, inside, outside, etc.) are relative orientations, which may be defined according to the use state of an ear physiological wearable device, and do not indicate or imply that the ear physiological wearable device needs to be constructed or operated in a specific direction, and these orientations should not be interpreted as limitation to the present invention.

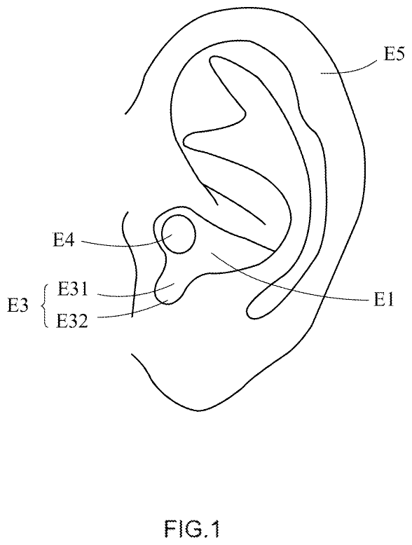

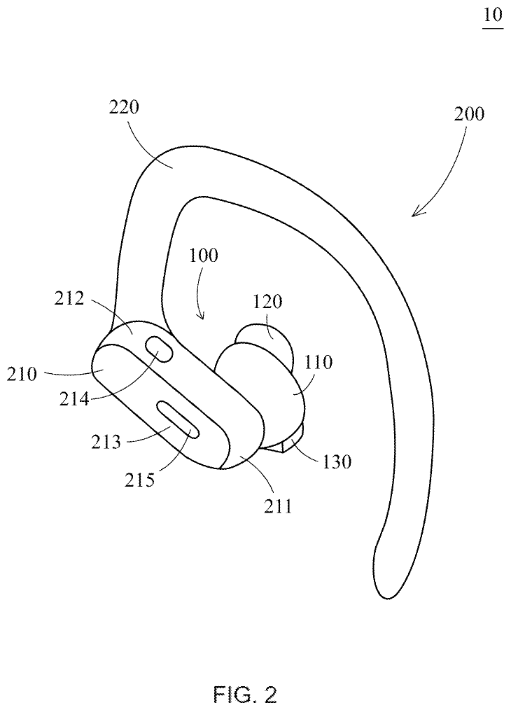

Please refer to FIG. 1, which is an explanatory diagram of various portions of a human ear. Please refer to FIG. 1 when explaining the wearing state of various components below. FIG. 2 is a schematic perspective view according to a first preferred embodiment of the present invention. An ear physiological wearable device 10 of the present invention (which is referred to as a device 10 for short hereinafter) may be worn in, on or around the ear by a user in single or in pairs, and may be connected with an external electronic device in a wired or wireless manner for data collection, statistics and calculation or the like. The device 10 may obtain power by being electrically connected to an external electronic device, or use the power stored by the power storage unit in the device 10. The device 10 comprises a main body 100 and a supporting body 200. The main body 100 comprises an acoustic driving portion 110, a temperature sensing portion 120 and an optical scanning portion 130. The acoustic driving portion 110 is disposed adjacent to the temperature sensing portion 120, and the optical scanning portion 130 is disposed below the acoustic driving portion 110 and the temperature sensing portion 130. Technical contents of each of the elements are sequentially described as follows.

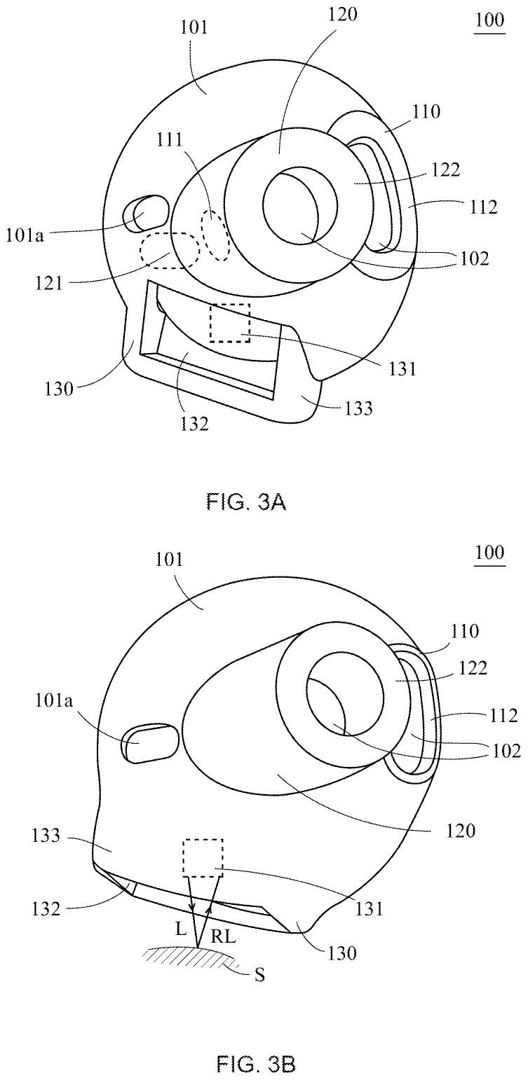

Please refer to FIG. 3A and FIG. 3B together, which are schematic perspective views of a main body 100 of the ear physiological wearable device 10 in the first preferred embodiment of the present invention. The main body 100 may comprise a housing 101 and an inner cavity 102, and the inner cavity 102 is defined by the housing 101. That is, the inner cavity 102 is a space enclosed by the housing 101. The housing 101 may be made of soft and/or hard materials alone or in combination, and has a general shape to suit E1 of many users, such as an egg shape and an oval shape, without being limited thereto. According to special requirements, it may also be customized to meet the shape of a cavity of auricular concha E1 of a single user. When soft materials are selected, the soft materials may be made of silicon rubber materials with low hardness to provide comfortable feeling when being worn. The housing 101 may also have at least one via 101a, so as to reduce the feeling of occlusion when the main body 100 is partially located in the ear during the wearing of the device 10.

The acoustic driving portion 110 may comprise a sound-generating unit 111 and an acoustic outlet 112. The sound-generating unit 111 is disposed in the inner cavity 102, the acoustic outlet 112 is disposed on the housing 101, and the acoustic outlet 112 may be an aperture constituted when the housing 101 is molded. When the device 10 is in operation, the sound-generating unit 111 may convert electronic signals into sound waves and transmit them to the outside from the acoustic outlet 112.

The temperature sensing portion 120 may comprise an infrared temperature sensing module 121 and a nozzle 122. The infrared temperature sensing module 121 is disposed in the inner cavity 102, and the nozzle 122 is disposed on the housing 101. The nozzle 122 may be in the shape of a tube column and extend outward from the surface of the housing 101, and the diameter away from the housing 101 is smaller than the diameter closer to the housing 101. When the device 10 is in operation, the infrared temperature sensing module 121 may detect the heat radiation generated by an eardrum E2 of the user through the nozzle 122, generate an electrical signal and convert it into a temperature value (i.e., the ear temperature of the user). For example, it may be similar to the sensing principle of an ear thermometer, but not completely equivalent to an ear thermometer.

The optical scanning portion 130 may comprise an optical volume scanning module 131 and an opening 132. The optical volume scanning module 131 is disposed in the inner cavity 102 and may comprise a light emitting component and a light receiving component to emit light L and receive reflected light RL. The opening 132 may be defined by outer walls 133, and the outer walls 133 may protrude outward from the surface of the housing 101 and connect with each other, thereby forming the opening 132 toward the inner side of the user's ear or the inner lower side of the user's ear. When the device 10 is in operation, the light volume scanning module 131 may emit light L, which will irradiate the skin S of the user's ear through the opening 132, and the light volume scanning module 131 also receives the reflected light RL reflected from the skin S through the opening 132. Therefore, the light volume scanning module 131 may sense the change of blood pulsatile flow in blood vessels under the skin through the amount of light L transmitted or reflected through the skin S, and convert it into electrical signals to calculate physiological information such as heartbeat, blood pressure, blood oxygen, blood perfusion index and the like of the user.

When the user wears the device 10, the outer walls 133 may abut against the skin in the ear of the user, so as to reduce the influence of light from the external environment of the ear on the detection accuracy. Preferably, the opening 132 may inwardly face an inner side E31 (FIG. 3A) of the incisura intertragica E3 of the user or downwardly face an inner lower side E32 (FIG. 3B), thereby detecting the physiological information of the user corresponding to the artery with obvious changes in blood flow in the ear. Of course, it is also possible to move the position of the opening 132 to other ear positions that have obvious changes in blood flow or may further reflect certain physiological conditions according to the changes of users and the corresponding research literature results, thereby obtaining the required physiological information.

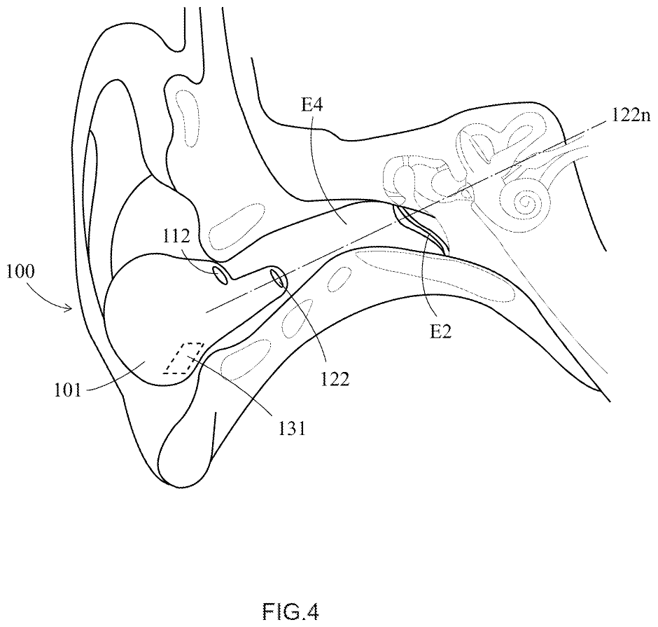

Please refer to FIG. 4 at the same time. In the first preferred embodiment, the acoustic outlet 112 is disposed adjacent to the nozzle 122, and is closer to the outside of the housing 101 (away from the user when being worn), while the nozzle 122 is closer to the inside of the housing 101 (close to the user when being worn). When the user wears the device 10, the temperature sensing portion 120 may further extend toward the ear canal E4 of the user, so that the nozzle 122 is located in the ear canal E4. The acoustic outlet 112 also extends toward the ear canal E4 of the user, but the position thereof is not as deep as that of the nozzle 122. Preferably, a normal 122n of the nozzle 122 may pass through the eardrum E2 of the user to accurately measure the ear temperature.

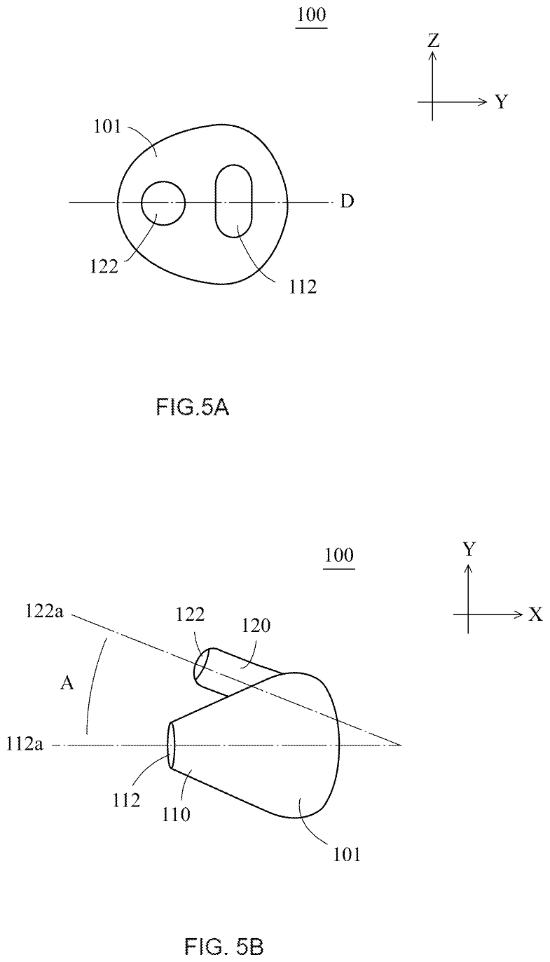

Please refer to FIG. 5A to FIG. 5B, which are respectively a side view and a top view of the main body 100. When the main body 100 is viewed from the side, the bisector D of each of the acoustic outlet 112 and the nozzle 122 may be parallel to each other or even completely overlapped. The acoustic outlet 112 has a central axis 112a, and the nozzle 122 has a central axis 122a. When the main body 100 is viewed from the top, an angle A is included between the central axes 112a and 122a, and the angle A is not greater than 30 degrees. In this way, the volume of the device 10 at one end of the acoustic outlet 112 and the nozzle 122 may be reduced, and the discomfort when wearing the device 10 and the acoustic energy loss caused by blockage when inserting the device into the ear may be avoided without affecting the temperature sensing, which would otherwise affects the quality of sound transmission. Moreover, it is convenient for the user to measure body temperature and/or receive sound messages without moving or adjusting the device 10.

Referring to FIG. 2 again, a supporting body 200 comprised in the device 10 may comprise a first operating portion 210 and a supporting portion 220. The first operating portion 210 is connected with the main body 100, may be generally located on the opposite sides of the acoustic outlet 112 and the nozzle 122 (the outside of the ear and the main body 100), extends from the outside of the ear to the front of the ear, and comprises a shell 211. The shell 211 is provided with a finger contact area 212 and an indication area 213 on the surface thereof. The finger contact area 212 may be an area on the surface of the shell 211 that may be touched by a user's finger, and may be provided with a manipulation component 214. The manipulation component 214 may be electrically connected with the acoustic driving portion 110, the temperature sensing portion 120 and/or the optical scanning portion 130 of the main body 100, so that a user may input a control signal for opening and/or closing through the manipulation component 214. Of course, each module may also have a fixed starting number and time by default, which need not be additionally controlled by the operating component 214. For example, the temperature sensing portion 120 and/or the optical scanning portion 130 may be set to start detection every few minutes, and each time of detection lasts for several seconds, so as to continuously monitor the physiological condition of the user. The manipulation component 214 may comprise buttons, knobs and/or touch panels or the like, to provide users with various manipulation modes. The indication area 213 may be an area where the surface of the shell 211 faces outwards, and is provided with at least one indicator lamp 215. The light color of the indicator lamp 215 may be predetermined to change according to the physiological condition of the user (for example, when the temperature sensing portion 120 and/or the optical scanning portion 130 senses that the ear temperature or heart rate of the user exceeds a preset value, red is presented), or it may be combined with other plural indicator lamps to form an icon or text (not shown) for external personnel to quickly identify the physiological condition of the user, thereby providing assistance.

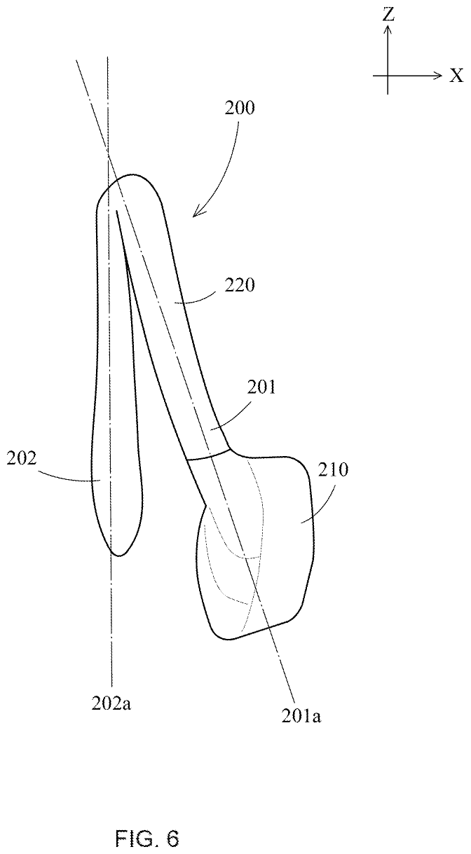

Please refer to FIG. 6, which is a side view of the supporting body 200 in the X-Z plane. The supporting portion 220 may have a front end 201 connected to the first operating portion 210 and a rear end 202 connected to the front end 201, each of the front end 201 and the rear end 202 comprises an extension axis normal 201a, 202a, and the two extension axis normals 201a and 202a are located in different planes. In other words, if the extension axis normal 202a is placed vertical to the X plane, then the extension axis normal 201a inclines relative to the extension axis normal 202a and extends toward the user, so that the front end 201 is closer to the user than the rear end 202, thereby improving the degree at which the support portion 220 conforms to the user's ear when wearing the device 10 and improving the wearing stability. In addition, the supporting portion 220 may have a shape corresponding to the outer helix E5 (similar to an inverted U shape), so that the device 10 may also be comfortably worn on the outer helix E5 of the user besides being inserted into the ear.

The first operating portion 210 may further have a data transmission module (not shown). The data transmission module may comprise a memory, a wireless signal transmission module, a microprocessor or the like, and is disposed inside the shell 211 to wirelessly receive messages from the outside of the device 10 or provide data to other electronic devices outside the device 10. Alternatively, the data transmission module may further comprise at least one connection port (not shown, e.g., an interface conforming to Micro USB communication protocol interface specification), is disposed on the surface of the shell 211 to transmit/receive messages in a wired way. The data transmission module may also be selectively disposed in the main body 100 to reduce the size of the device 10.

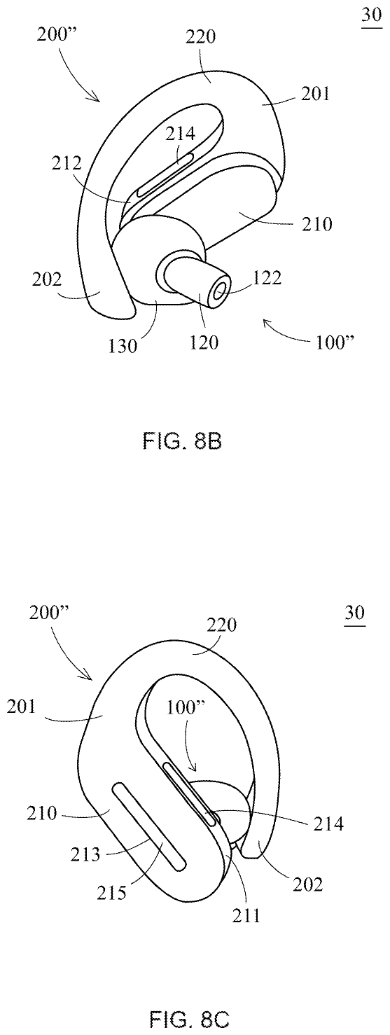

The first operating portion 210 and the supporting portion 220 may be manufactured independently and then combined with each other, or manufactured integrally. As shown in FIG. 8C, the first operating portion 210 is partially integrated with the supporting portion 220. That is, a part of the first operating portion 210 (e.g., the outer surface and the portion contacting with the ear) is made of the same soft material as the supporting portion, and the rest (e.g., the shell covering a plurality of modules inside) is made of hard plastic material to maintain the appearance thereof.

It shall be noted that, the structure and shape of the supporting body 200 may not be limited to the above embodiments. According to the development of ear research, the supporting body 200 may be replaced with other ergonomic forms, such as the supporting portion of a hearing aid, to provide more comfortable wearing.

In addition, the device 10 may further comprise a dynamic sensing module, such as a multi-axis sensor including a gyroscope, an accelerometer or the like, so that the device 10 may detect the dynamic information of the user, and further provide functions such as fall warning, motion detection, and detection data correction. The acoustic driving portion 110, the temperature sensing portion 120 and the optical scanning portion 130 comprised in the main body 100 may also be electrically connected with each other so as to be started in conjunction with each other. For example, when the temperature sensing portion 120 and/or the optical scanning portion 130 sense that the physiological information of the user is out of a preset range, the acoustic driving portion 110 may be driven to generate sound to remind the user of the physiological condition thereof. The device 10 may also comprise a radio module, so that a plurality of devices may have a voice communication function. With the above settings, the present invention may remind the user to pay attention to the physiological condition, and may also allow external personnel to observe physiological conditions of many people at the same time, and may be further applied to directly, instantly and clearly transmit messages to many people at the same time, so as to for example omit broadcasting and avoid the case of unclear hearing due to the environment, and is suitable for situations such as military training, team training, nursing care or the like.

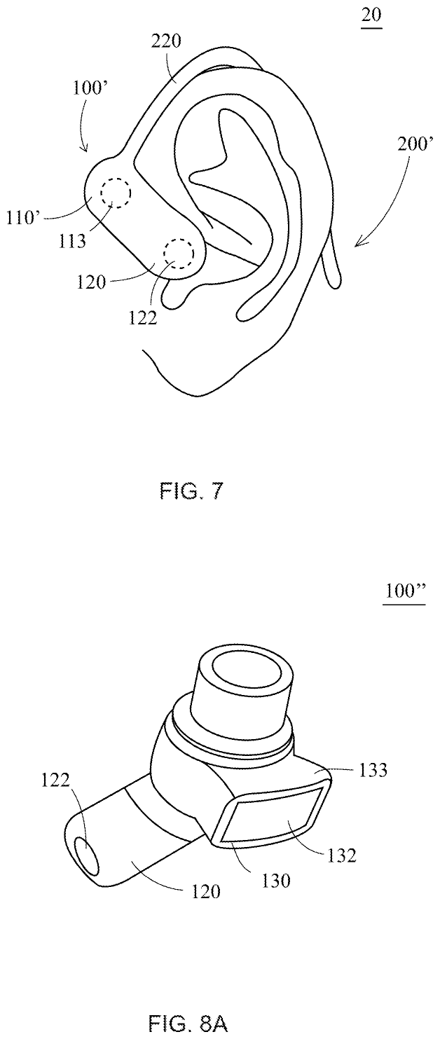

Next, please refer to FIG. 7, which is a schematic perspective view of an ear physiological wearable device 20 being worn according to a second preferred embodiment of the present invention, and the ear physiological wearable device 20 comprises a main body 100′ and a supporting body 200′. The main body 100′ and the supporting body 200′ are substantially similar to the main body 100 and the supporting body 200 respectively, and contents that may be referred to each other will not be described in detail. The acoustic driving portion 110′ of the main body 100′ comprises an acoustic end 113, and the acoustic end 113 may not be provided with an opening. As shown in the figure, the supporting portion 220 of the supporting body 200′ is directly connected with the main body 100′, but may optionally comprise a first operating portion or a second operating portion. When a user wears the ear physiological wearable device 20, the acoustic end 113 abuts against the skull of the user, such as the cheek bones of the face, temporal bone, etc., and converts the electronic signal into vibration, which is directly transmitted to the inner ear of the user through the bones so that the user may hear the sound. In this way, the temperature measurement function and the sound transmission function may not interfere with each other, and each of them has more room for adjustment and optimization, so that the user may wear the device for a long time without worrying about hearing damage.

Next, please refer to FIG. 8A to FIG. 8C, which are schematic perspective views of an ear physiological wearable device 30 according to a third preferred embodiment of the present invention, and the ear physiological wearable device 30 comprises a main body 100″ and a supporting body 200″. The main body 100″ and the supporting body 200″ are substantially similar to the main body 100 and the supporting body 200, and contents that may be referred to each other have the same reference numbers, and thus will not be further described in detail. In other words, the main body 100″ of the device 30 may optionally have an acoustic driving portion 110. When the device 30 does not have an acoustic driving portion, the device 30 has no sound transmission function, and only comprises the temperature sensing portion 120 and the optical scanning portion 130. In this way, the ear physiological wearable device 30 may be reduced in size and weight and improved in physiological sensing function. When the device 30 has the acoustic driving portion, it may further comprise a sound-generating unit (not shown; reference may be made to the first embodiment) to convert electronic signals into sound waves and transmit them to the ear canal of the user from the nozzle 122 of the temperature sensing portion 120. That is, the acoustic driving portion of the device 30 is acoustically coupled with the nozzle 122, and the sound is transmitted through the nozzle 122 without providing an acoustic outlet, thereby achieving the effects of transmitting sound information, reducing the volume of the ear physiological wearable device 30 and improving the sound transmission quality or the like.

According to the above descriptions, the ear physiological wearable device of the present invention comprises an acoustic driving portion, a temperature sensing portion and/or an optical scanning portion, which may be used by the user to monitor the ear temperature, heart rate, blood pressure and other status in real time, receive/send sound messages or the like, and thus the user may instantly know the body status thereof without watching the display panel or using an external device. The ear physiological wearable device may further comprise an indication area for external personnel to intuitively and quickly perceive the abnormal status of the user and give corresponding assistance in real time.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An ear physiological wearable device, comprising:
a main body, including an acoustic driving portion, a temperature sensing portion and an optical scanning portion, wherein the acoustic driving portion is adjacent to the temperature sensing portion, and the optical scanning portion is disposed below the acoustic driving portion and the temperature sensing portion; and
a supporting body, being connected to the main body for a user to wear the ear physiological wearable device;
wherein the acoustic driving portion includes an acoustic outlet, the temperature sensing portion includes a nozzle, when the user wears the ear physiological wearable device, the acoustic outlet and the nozzle face to the ear canal of the user.

2. The ear physiological wearable device of claim 1, further comprising a wireless signal transmission module electrically connected with the acoustic driving portion, the temperature sensing portion and the optical scanning portion.

3. The ear physiological wearable device of claim 1, wherein an angle is included between the acoustic outlet and the nozzle, and the angle is not great than 30 degrees.

4. The ear physiological wearable device of claim 1, wherein the optical scanning portion includes an opening, and when the user wears the ear physiological wearable device, the opening faces the incisura intertragica of the user.

5. The ear physiological wearable device of claim 1, wherein the supporting body comprises a first operating portion and a supporting portion, the supporting portion is connected with the first operating portion, and when the user wears the ear physiological wearable device, the supporting portion is located on the outer helix or beside the back of the ear of the user.

6. The ear physiological wearable device of claim 5, wherein a central axis of the first operating portion is inclined relative to an extension axis normal of the supporting portion.

7. The ear physiological wearable device of claim 5, wherein the first operating portion includes a finger contact area and an indication area.

8. An ear physiological wearable device, comprising:
a main body, including an acoustic driving portion, a temperature sensing portion and an optical scanning portion, wherein the acoustic driving portion is disposed above the temperature sensing portion, and the optical scanning portion is disposed below the temperature sensing portion; and
a supporting body, being connected to the main body for a user to wear the ear physiological wearable device;
wherein the acoustic driving portion includes an acoustic end, the temperature sensing portion includes a nozzle, when the user wears the ear physiological wearable device, the acoustic end abuts against the user's skull and generates vibrations, and the temperature sensing portion extends along the ear canal of the user, so that the nozzle is positioned in the ear canal of the user.

9. The ear physiological wearable device of claim 8, further comprising a wireless signal transmission module electrically connected with the acoustic driving portion, the temperature sensing portion and the optical scanning portion.

10. An ear physiological wearable device, comprising:
a main body, including a temperature sensing portion and an optical scanning portion, wherein the temperature sensing portion is adjacent to the optical scanning portion; and
a supporting body, being connected with the main body, and abutting against the ear of the user when the user wears the ear physiological wearable device;
wherein the temperature sensing portion comprises a nozzle, the optical scanning portion comprises an opening, and when the user wears the ear physiological wear device, the temperature sensing portion extends along the ear canal of the user, so that the nozzle is positioned in the ear canal of the user, and the opening corresponds to the incisura intertragica of the user.

11. The ear physiological wearable device of claim 10, wherein the main body further comprises an acoustic driving portion which is acoustically coupled with the nozzle.
